(19) United States
(12) Patent Application Publication
(10) Pub. No.: US 2008/0230312 A1
(43) Pub. Date: Sep. 25, 2008

(54) Vehicle Supported, Portable Scaffold System

(75) Inventor: Dale Van Havermaet, Grey Eagle, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: EZ Lift, LLC, Grey Eagle, MN (US)

(21) Appl. No.: 12/092,258

(22) PCT Filed: Nov. 2, 2006
(86) PCT No.: PCT/US06/42831

§ 371 Date: Apr. 30, 2008

(51) Int. Cl. B66B 9/16

(52) U.S. Cl. 182/63.1

(57) ABSTRACT

A vehicle-supported, portable scaffold system. The scaffold system includes a frame structure having a vertical tower and a base. The vertical tower operably supports a platform assembly vertically movable along a length of the vertical tower between a lowermost position and an uppermost position. An actuator is operably disposed to selectively move the platform assembly along the length of the vertical tower between the lower most position and the uppermost position. A vehicle mount is adapted to securely but removably attach the scaffold system to a vehicle, wherein during use, the vehicle remains attached to the scaffold system for stability.

### CROSS-REFERENCE TO RELATED APPLICATIONS

The present application claims priority to U.S. Provisional Patent Application No. 60/596,977 filed on Nov. 2, 2005 and titled VEHICLE-SUPPORTED, PORTABLE SCAFFOLD SYSTEM, the contents of which are incorporated by reference herein in their entirety.

### BACKGROUND OF THE INVENTION

Platform lifts for lifting workmen and materials to work areas elevated above ground level are well known. It is also well known to provide mobile scaffolding or platform lifts which mount to vehicles for transporting between jobsites and for supporting the platform during use. Examples of such vehicle mounted scaffolding or platform lifts include U.S. Pat. No. 3,493,079 to Dudschus; U.S. Pat. No. 3,666,046 to Meinecke, Jr.; U.S. Pat. No. 3,826,334 to Spillman; U.S. Pat. No. 5,096,018 to Dickinson, Jr.; U.S. Pat. No. 5,497,851 to Walcher et al; U.S. Pat. No. 5,551,527 to Luscombe; U.S. Pat. No. 5,555,953 to Henderson; U.S. Pat. No. 5,586,616 to Ksenych; and U.S. Pat. No. 6,595,330 to Henrickson et al.

While each of the foregoing patented inventions may serve their intended purpose, there remains a need for a vehicle-supported, portable scaffolding system which offers many of the same features and advantages associated with certain of these prior patented inventions, but which also offers additional benefits, features and advantages such as those provided by the present invention which will become apparent from the following written description and accompanying drawings.

### SUMMARY OF THE INVENTION

The present invention is directed toward a vehicle-supported, portable scaffold system. The scaffold system comprises a frame structure having a vertical tower and a base. The vertical tower operably supports a platform assembly vertically movable along a length of the vertical tower between a lowermost position and an uppermost position. An actuator is operably disposed to selectively move the platform assembly along the length of the vertical tower between the lower most position and the uppermost position. A vehicle mount is adapted to securely but removably attach the scaffold system to a vehicle, wherein during use, the vehicle remains attached to the scaffold system for stability.

### BRIEF DESCRIPTION OF THE DRAWINGS

FIG. 1 is a perspective view of a preferred embodiment of the vehicle-supported, portable scaffold system of the present invention.

FIG. 2 is a right side elevation view of the scaffold system of FIG. 1 showing a vehicle attached to the vehicle mount and with the platform assembly in the lowermost position.

FIG. 3 is a right side elevation view of the scaffold system of FIG. 2 with the platform assembly in the uppermost position.

FIG. 4 is a back side elevation view of the scaffold system of FIG. 1 with the platform assembly in the lowermost position.

FIG. 5 is a top plan view of the scaffold system of FIG. 2.

FIG. 6 is a cross-sectional view of a portion of the platform carriage assembly as viewed along lines 6-6 of FIG. 4.

FIG. 7 is a partial cross-sectional view of the roller assembly as viewed along lines 7-7 of FIG. 6.

### DETAILED DESCRIPTION OF THE INVENTION

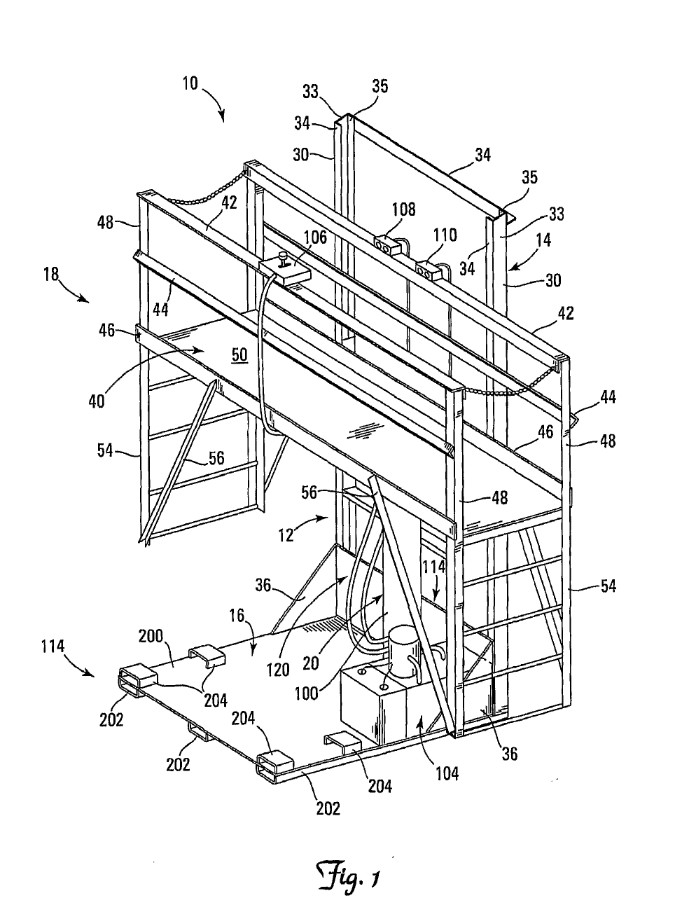

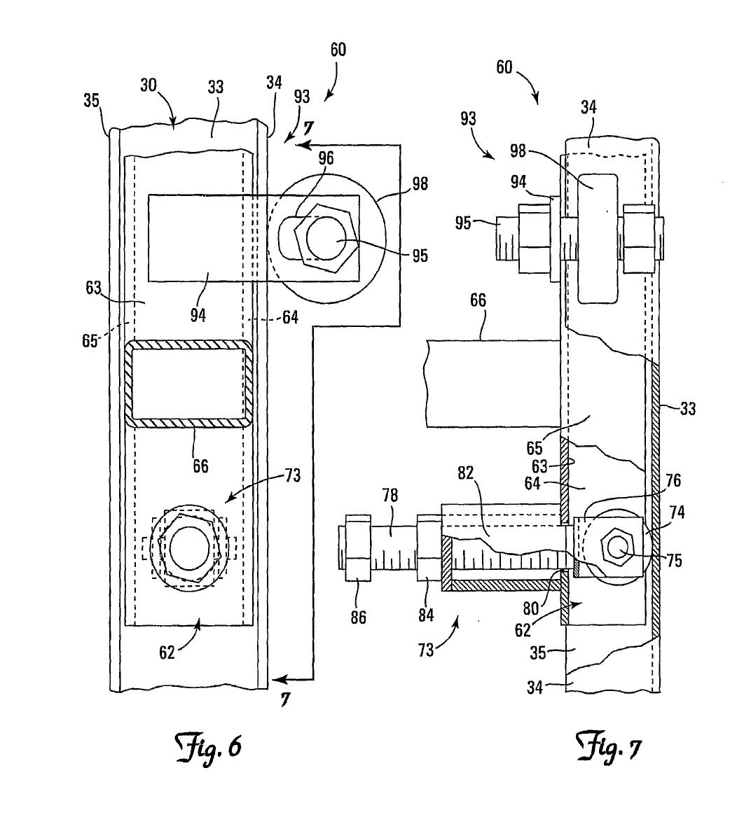

A preferred embodiment of the vehicle-supported, portable scaffold system of the present invention is identified generally by reference numeral 10 in drawing FIGS. 1-6. Like reference numerals are used throughout the drawing figures to designate identical or corresponding parts or features of the preferred embodiment of the invention 10 throughout the several views.

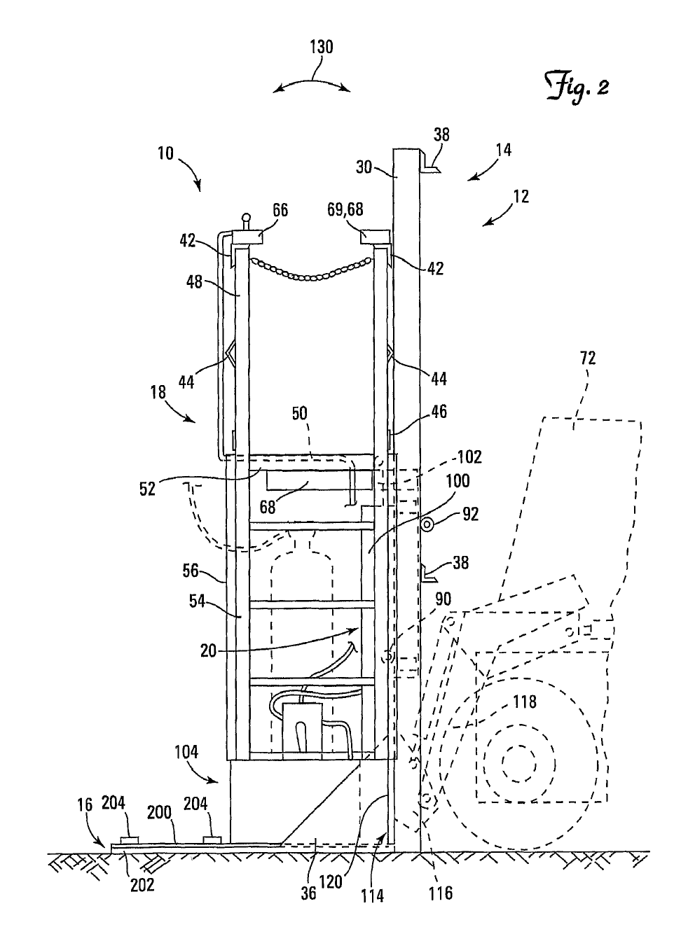

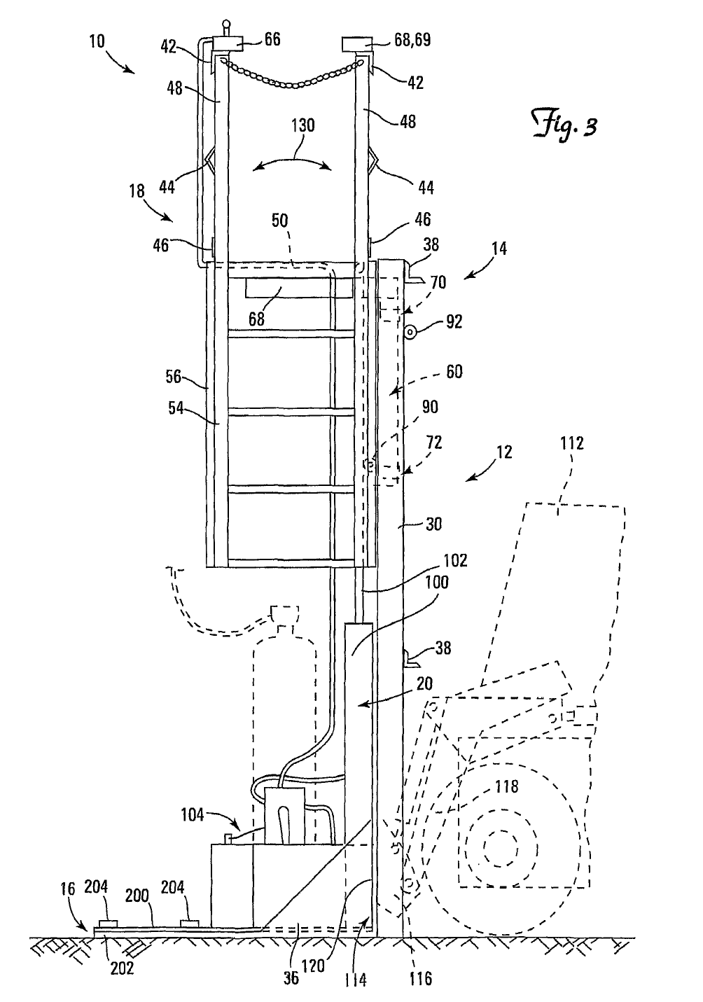

FIG. 1 is a perspective view of the preferred embodiment of the portable scaffold system 10 which comprises a fixed or stationary frame structure 12 having a vertical tower 14 and a base 16. The vertical tower 14 operably supports a horizontally disposed platform assembly 18. An actuator 20, (discussed in more detail later), is operably disposed to selectively move the platform assembly 18 along the length of the vertical tower 14 between a lower most position (FIG. 2) and an uppermost position (FIG. 3).

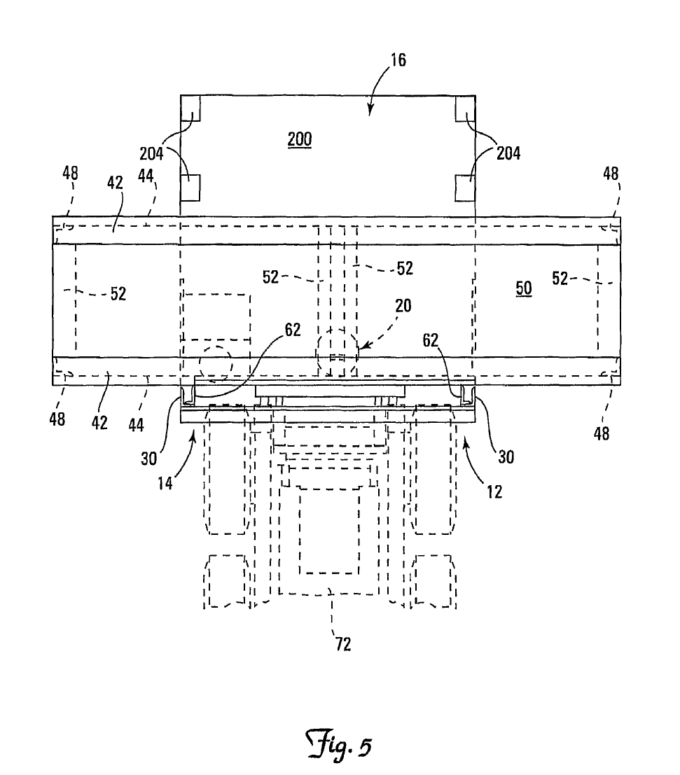

The vertical tower 14 preferably comprises two laterally spaced, vertical guide rails 30. In the preferred embodiment, each vertical guide rail 30 comprises a C-channel having a web 33 and flanges 34, 35. As best illustrated in FIG. 5, the C-channels are preferably disposed such that the flanges 34, 35 face inwardly toward the inwardly projecting flanges 34, 35 of the opposing C-channel guide rail 30. The vertical guide rails 30 are fixed at their lower end to the base 16 by gussets 36. Cross-members 38 (FIGS. 2 and 3) are spaced vertically along the length of the guide rails 30 to maintain a substantially uniform lateral spacing between the guide rails 30 along their height and to provide lateral stability to the tower 14.

The base 16 is preferably sized to support the actuator 20 and any required pump, reservoir and power source for its operation (discussed later). In addition, as illustrated in FIGS. 2-4, the base 16 is preferably of sufficient size to carry other tools and equipment that may be needed for a particular job, including for example, a tool box, air compressor, electric generator, welders, gas tanks for cutting torches or other tools, etc.

In the preferred embodiment, the platform assembly 18 comprises an elevated platform 40 of a desired length and width, designed according to anticipated loading and usage requirements, and fabricated accordingly from desired materials, which may include steel, aluminum, wood or any other suitable material. Appropriate handrails 42, mid-rails 44, kick-plates 46 and hand rail posts 48, deck plate or other appropriated deck flooring material 50 and deck support members 52 are provided for the platform 40 in accordance with applicable Occupational Safety and Health Administration (OSHA) requirements or other applicable rules or regulations for working at heights. A ladder 54 is preferably provided at each end of the elevated platform 40 terminating at an acceptable step distance above the ground surface when the platform assembly 18 is at its lowermost position. Lateral bracing 56 is preferably provided for rigidity of the downwardly extending section of the ladder 54.

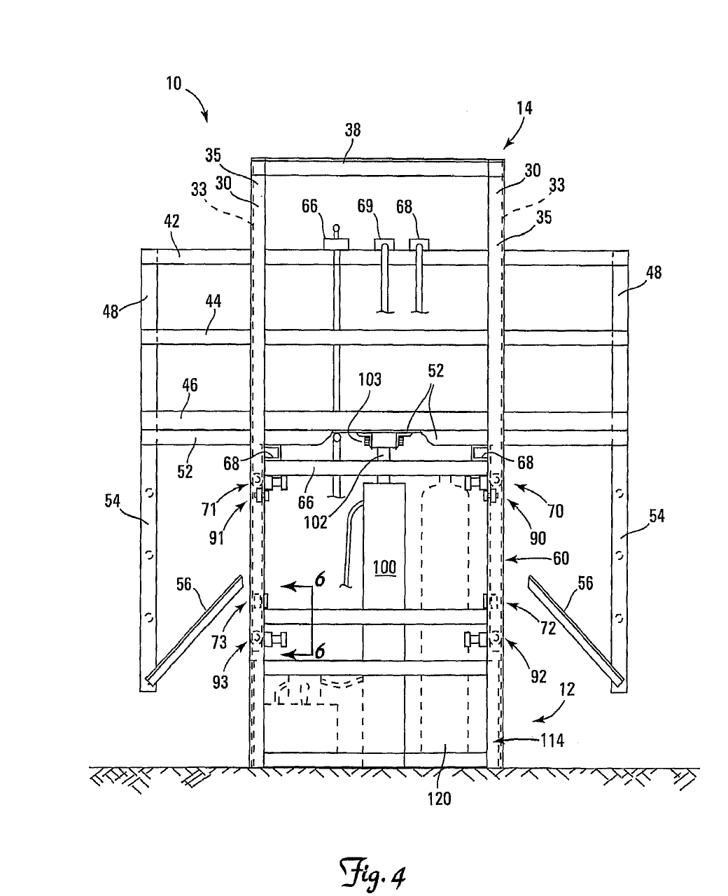

The platform assembly 18 is operably supported for vertical movement along the length of the vertical guide rails 30 by a platform carriage assembly 60. As best illustrated in FIG. 4, in the preferred embodiment, the platform carriage assembly 60 comprises two vertically disposed carriage rails 62 preferably comprising C-channels having a web 63 that is less than the web 33 of the vertical guide rails 30 and the legs or flanges 64, 65 of the carriage rails 62 preferably face outwardly toward the webs 33 of the guide rails 30 (see FIGS. 5 and 7). Beams 66 are preferably fixed to the back face of the webs 63 and are preferably of sufficient length so as to ensure that the outwardly projecting flanges 64, 65 of the carriage rails 60 are restrained between the inwardly projecting flanges 34, 35 of the guide rails 30. The platform 40 is preferably ultimately supported from the carriage assembly 60 by cantilever brackets 68.

The carriage assembly 60 also preferably includes four web roller assemblies 70, 71, 72, 73. The two top web roller assemblies 70, 71 are disposed toward the upper end of the carriage rails 62 and the two lower web roller assemblies 72, 73 are disposed toward the lower ends of the carriage rail 62. Each of the four web roller assemblies 70, 71, 72, 73 preferably comprises a roller or wheel 74 which is supported for rotation about pin 75 supported at each end by a clevis 76. The clevis 76 is fixed to one end of a threaded rod 78. The other end of the threaded rod 78 extends through an aperture 80 in the web 63 of the carriage rail 62 and through a sleeve 82. A nut 84 threaded onto the threaded rod 78 and is fixed to the sleeve 82. A second nut 86 is then fixed to the end of the threaded rod 78. By turning the threaded rod 78 clockwise and counterclockwise with respect to the sleeve 82 and nut 84, the rod 78 and thus the roller 74, operably fixed to the end thereof, moves outwardly and inwardly, respectively, relative to the carriage rail 62. By adjusting all four of the web roller assemblies 70, 71, 72, 73 accordingly, the carriage assembly 60 can be centered between the vertical guide rails 30, with each of the four rollers 74 engaging the web 33 of the vertical guide rails 30.

The carriage assembly 60 also preferably includes four flange roller assemblies 90, 91, 92, 93. Preferably the two bottom flange roller assemblies 90, 91 are disposed to roll along the front flanges 34 of the vertical guide rails 30, while the two top flange roller assemblies 92, 93 are disposed to roll along the back flanges 35 of the vertical guide rails 30. The preferred flange roller assemblies 90, 91, 92, 93 are preferably adjustable front to back such that the carriage rails 62 can be plumbed relative to the guide rails 30. In the preferred embodiment, the flange roller assembly comprises a bracket 94 which extends a distance past the edge of the guide rails 30. One end of a threaded rod 95 extends through an aperture 96 in the bracket 94. A roller 98 is secured to the other end of the rod 95. The aperture 96 may be elongated or slotted to allow the rod 95 to be moved back and forth within the slot to provide for front to back adjustment to enable the carriage assembly 60 to be plumbed relative to the guide rail 30.

Comparing FIGS. 2 and 3, it should be appreciated that the frame structure 12 (including the vertical tower 14 and base 16) remains stationary while the platform assembly 18 is caused to raise and lower by actuation of the actuator 20. In the preferred embodiment, the actuator 20 comprises a hydraulic cylinder 100. The type and size of the cylinder and piston, and length of stroke of the piston rod 102 may vary depending on anticipated loads for which the scaffolding system 10 is designed to support and the desired heights to which the platform assembly 18 is designed to be raised. As best illustrated in FIG. 4, the lower end of the cylinder housing 100 is secured to the base 16. The upper end of the movable piston rod 102 is secured to the underside of the platform 40 by a pin or other connection 103 between adjacently spaced deck members 52 disposed below the platform 40.

For operation of the hydraulic cylinder 100, an appropriately matched hydraulic system 104 is provided, including, a power source (such as a battery or generator), an appropriately sized hydraulic pump, hydraulic fluid reservoir, hydraulic hoses and a hydraulic actuator control 106, all of which is readily understood by those of ordinary skill in the art, and therefore further discussion and specific details of the hydraulic system 104 is not warranted. Preferably, the actuator control 106 is secured to the handrail 42 of the platform 40 for operation by the user while standing on the platform 40. In an alternative embodiment, the hydraulic cylinder 100 may be actuated by the hydraulic system and electrical system of the vehicle (discussed later) supporting the scaffold system 10.

In addition to the actuator control 106, an electrical outlet 108 and an air port manifold 110 may be secured to the handrail 42 or another part of the platform 40 for convenience by a user of the scaffold system for powering electrical or pneumatic tools, respectively. It should be understood, that the electrical wires and hoses extending between the outlet 108 and manifold 110 on the platform 40 and their respective sources (such as an electrical generator or air compressor (not shown)) disposed on the base 16 of the scaffold system 10, should either have sufficient length or otherwise should have the ability to expand or uncoil, etc., so that upon raising the platform 40, the wires and hoses are not pulled, strained or disconnected from their sources. It should be understood that providing an outlet 108 and air port manifold 110 overcomes significant disadvantages and challenges otherwise associated with having to use and rely on long extension cords or hoses when working at heights on a platform, including, for example, minimizing the extension cords and hoses becoming entangled with each other and other tools on the platform, reducing tripping hazards otherwise present when long cords or hoses are laying about the platform, minimizing the occurrence of cords or hoses getting hung-up on the handrails, and eliminating the occurrence of the cords or hoses becoming disconnected from the tool and fall back to the ground, forcing the user to return to the ground to retrieve the fallen cord or hose.

As best illustrated in FIGS. 2, 3 and 4, a vehicle mount 114 is provided to securely but removably attach the scaffold system 10 to a vehicle 112. During use, the vehicle 112 remains attached to the scaffold system 10 for stability. As illustrated, the scaffold system 10 of the present invention is shown particularly adapted for use with a skid steer, such as, for example, a Bobcat® skid steer as sold by the Bobcat Company, a business unit of Clark Equipment Company, which is a subsidiary of Ingersoll-Rand Company, Woodcliff Lake, N.J. It should be appreciated however, that the scaffold system 10 of the present invention may be adapted for use with any type of vehicle, and, therefore, the present invention should not be construed as being limited to use with skid steers.

In the preferred embodiment, the vehicle mount 114, is preferably adapted to allow the vehicle 112 to be quickly and easily attachable and detachable from the scaffolding system 10. Skid steers are generally equipped with a carrier 116 mounted on its lift arms 118. The carrier 116 is configured to cooperate with a latch plate mounted onto the bucket, fork, blade, or other tool designed for use with the skid steer to enable the operator to quickly and easily attach and detach the tool. Examples of such quick-attach carrier assemblies are disclosed in U.S. Pat. No. 3,732,996 to Bauer, U.S. Pat. No. 3,984,016 to Kuhn, and U.S. Pat. No. 4,436,477 to Lenertz et al., to name but a few, each of which is incorporated herein by reference. Of course, the vehicle mount 114 may vary as identified in the above-referenced patents depending on the type of vehicle and on the tool. For purposes of illustration only, in FIGS. 2 and 3, the scaffold assembly 10 of the present invention is shown with the vehicle mount 114 comprising a latch plate 120 (such as the type disclosed in the above-referenced Kuhn '016 patent) fixed to the vertical tower 14 and base 16, and is adapted to receive and cooperate with the carrier 116 (such as the type disclosed in the above-referenced Kuhn '016 patent) mounted on the lift arms 118 of a skid steer vehicle 112. It should be appreciated that the hydraulic actuators of the lift arms 118 can be extended or retracted as needed to cause the vehicle mount 114 and scaffold system 10 attached thereto to tip forwardly and rearwardly as indicated by arrow 130 in FIGS. 2 and 3 for leveling the scaffold system front to back.

In alternative embodiments, rather than the vehicle mount 114 comprising a latch plate 120 and carrier, the vehicle mount 114 may be incorporated in or form a part of the base 16 which is adapted to receive or mount directly to the skid steer tool, such as the forks, blade or bucket. For example, FIG. 1 illustrates a vehicle mount 114 adapted to receive and cooperate with the forks of the skid steer or fork lift vehicle (not shown). For example, the base 16 may be constructed in a manner similar to a conventional wood or steel pallet in which a top surface 200 of the base 16 is raised above a ground or floor surface by spaced boards or other base-support members 202 between which the forks are received. Alternatively, the base 16 may include top mounted brackets 204 for receiving the forks. It should be understood that the base support members 202 may be oriented with respect to the top surface 200 in different directions to accommodate reception of the forks or other tools from different sides of the base 16. Likewise, the top-mounted brackets 204 may be oriented with respect to the top surface 200 in different directions to accommodate reception of the forks or other tools from different sides of the base 16.

With the foregoing construction, the vehicle-supported, scaffold system 10 of the present invention provides an economic, portable platform for lifting workman and materials to areas elevated above the ground surface. The scaffold system 10 is stable as a result of being secured to the vehicle while in use. The system 10 does not require separate outriggers or supports for stability and therefore may be used in confined areas or in close proximity to other structures. The invention further provides a self contained system that enables the tools, equipment and other materials to be transported with the platform.

Although only certain exemplary embodiments of the applicants' present invention have been described in detail above, those skilled in the art will readily appreciate that many modifications are possible without materially departing from the novel teachings and advantages of this invention. Accordingly, all such modifications are intended to be included within the scope of this invention as defined in the following claims.

1. A vehicle-supported, portable scaffold system, comprising:
a) a fixed frame structure having a base and a vertical tower;
b) a horizontally disposed platform assembly vertically movable along a length of said vertical tower between a lowermost position and an uppermost position;
c) an actuator operably disposed to selectively move said horizontally disposed platform with respect to said vertical tower; and
d) a vehicle mount adapted to removably attach a vehicle to said fixed frame structure.

2. The vehicle-supported, portable scaffolding system of claim 1 wherein said vehicle mount includes a latch plate that cooperates to removably attach with a carrier mounted on the vehicle.

3. The vehicle-supported, portable scaffolding system of claim 1 wherein said vehicle mount is incorporated into said base, and wherein tools disposed on the vehicle cooperate to removably attach with the vehicle mount.

4. The vehicle-supported, portable scaffolding system of claim 1 further comprising an actuator control positioned on said horizontally disposed platform for controlling said actuator therefrom.

5. The vehicle-supported, portable scaffolding system of claim 4 further comprising an electrical outlet positioned on said horizontally disposed platform and accessible therefrom.

6. The vehicle-supported, portable scaffolding system of claim 5 further comprising an air port manifold positioned on said horizontally disposed platform and accessible therefrom.

7. The vehicle-supported, portable scaffolding system of claim 1 wherein said vertical tower comprises at least one vertical guide rail extending from said base.

8. The vehicle-supported, portable scaffolding system from claim 7 wherein said horizontally disposed platform assembly is coupled to said vertical guide rail by a platform carriage assembly.

9. In combination, a vehicle and a portable scaffolding system, wherein the vehicle remains secured to the portable scaffolding system during use thereof, said portable scaffolding system, comprising:
a) a fixed frame structure having a base and a vertical tower extending therefrom wherein said fixed frame structure further comprises a vehicle mount;
b) a horizontally disposed platform assembly vertically movable along a length of said vertical tower between a lowermost position and an uppermost position;
c) an actuator operably disposed to selectively move said horizontally disposed platform with respect to said vertical tower
d) a vehicle support to which the vehicle is removably attached during use of the portable scaffolding system.

10. The combination of claim 9 wherein said vehicle mount includes a latch plate that cooperates to removably attach with a carrier mounted on the vehicle.

11. The combination of claim 9 wherein said vehicle mount is incorporated into said base, and wherein tools disposed on the vehicle cooperate to removably attach with the vehicle mount.

12. The combination of claim 10 wherein said vehicle is a skid steer.

13. The combination of claim 11 wherein said vehicle is a skid steer.

14. The combination of claim 11 wherein said tools disposed on the vehicle include forks.
